(19) United States
(12) Patent Application Publication
(10) Pub. No.: US 2007/0066704 A1
(43) Pub. Date: Mar. 22, 2007

(54) Radiation-hardenable coating agent containing aliphatic urethane (meth) acrylate

(75) Inventors: Reinhold Schwalm, Wachenheim (DE); Peter Enenkel, Hebheim (DE); Harald Larbig, Ludwigshafen (DE); Yvonne Heischkel, Mannheim (DE); Manfred Biehler, Ilbesheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/574,686

(22) PCT Filed: Oct. 5, 2004
(86) PCT No.: PCT/EP04/11115

§ 371 Date: Apr. 5, 2006

(30) Foreign Application Priority Data
Oct. 6, 2003 (DE) 103 46 327.5

(51) Int. Cl. C08F 2/46

(52) U.S. Cl. 522/173

(57) ABSTRACT

The present invention relates to a radiation-curable coating composition comprising at least one aliphatic urethane (meth)acrylate which has two ethylenically unsaturated double bonds per molecule and contains at least one polytetrahydrofurandiol in built-in form and at least one monoethylenically unsaturated reactive diluent. The invention further provides a process for producing a coated substrate using such a radiation-curable coating composition and to the coated substrates obtained by this process.

The present invention relates to a radiation-curable coating composition comprising at least one aliphatic urethane (meth)acrylate which has two ethylenically unsaturated double bonds per molecule and contains at least one polytetrahydrofurandiol in built-in form and at least one monoethylenically unsaturated reactive diluent. The invention further provides a process for producing a coated substrate using such a radiation-curable coating composition and to the coated substrates obtained by this process.

Radiation-curable compositions have achieved wide use in industry, in particular as high-quality coating materials for surfaces. For the purposes of the present invention, radiation-curable compositions are compositions which comprise ethylenically unsaturated polymers or prepolymers and which, if appropriate after a physical drying step, are cured by action of high-energy radiation, for example by irradiation with UV light or by irradiation with high-energy electrons (electron beam).

To meet the demands made by consumers on surface coatings in the interior and exterior sectors, radiation-curable coating compositions have to have a complex property profile. This includes, firstly, a high surface hardness and a good chemical resistance. In addition, there is a desire for coatings which have a high scratch resistance so that the coating is not damaged during, for example, cleaning and loses its gloss. Especially for applications in the exterior sector, a high resistance to weathering, in particular a low tendency to undergo yellowing and a high hydrolysis stability, is necessary. This requires, firstly, the use of coatings building blocks, i.e. components of the radiation-curable coating compositions, which are photochemically, hydrolytically and oxidatively stable. Furthermore, these should also be compatible with additional components, e.g. UV absorbers and free-radical scavengers, and nevertheless cure reliably. A fundamental problem associated with the radiation-curable compositions of the prior art is that although individual use properties can be improved by selection and matching of the components (radiation-curable polymer and reactive diluent), this is generally at the expense of other use properties. There is therefore a continuing need for radiation-curable coating compositions which have a highly optimized property profile, in particular for exterior applications.

In Polymers Paint Color Journal, Volume 182 (1992), pages 406-411, A. Valet describes the use of UV-absorbers and free-radical scavengers in radiation-curable coating compositions for exterior applications in order to improve the weathering stability.

U.S. Pat. No. 4,153,778 describes urethane acrylate oligomers which contain a polytetramethylene oxide diol in copolymerized form and their use as coatings, binders and adhesives. These may contain further components such as ethylenically unsaturated monomers.

JP-A-62054710 describes a urethane acrylate composition comprising a urethane acrylate having a polyalcohol group in the polymer chain and a further polymerizable monomer such as styrene or methyl methacrylate.

JP-A-01216837 describes film coatings having a good scratch resistance, impact resistance and abrasion resistance. These are produced using a urethane acrylate oligomer based on a diol having a number average molecular weight of from 200 to 4000.

U.S. Pat. No. 4,129,667 describes radiation-curable coating compositions comprising a urethane acrylate oligomer and a UV absorber. The urethane acrylates used can have repeating units derived from polytetrahydrofuran. In addition, the coating composition can further comprise monomers, e.g. monoesters, diesters and higher esters of acrylic acid and methacrylic acid, which can be copolymerized with the urethane acrylate.

U.S. Pat. No. 4,135,007 has a disclosure content comparable to U.S. Pat. No. 4,129,667.

DE-A-199 40 313 describes a process for producing scratch-resistant and weathering-resistant coatings, in which a liquid, UV-curable coating composition based on aliphatic urethane (meth)acrylate prepolymers is applied to a substrate to be coated and the still liquid coating is subsequently cured by means of UV radiation with substantial exclusion of oxygen.

DE-A-197 39 970 describes radiation-curable compositions comprising at least one prepolymer containing aliphatic urethane groups and at least one monofunctional ester of an α,β-ethylenically unsaturated carboxylic acid with a monofunctional alkanol which contains at least one saturated 5- or 6-membered carbocycle or a corresponding heterocycle having one or two oxygen atoms in the ring as structural element.

It is an object of the present invention to provide flexible radiation-curable coating compositions which are suitable for exterior applications. These should have good use properties, e.g. good mechanical properties, low odor and high reactivity. In particular, they should have a good resistance, in particular a high scratch resistance, a high flexibility and a low tendency to undergo yellowing.

We have found that this object is achieved by a radiation-curable coating composition comprising
a) at least one aliphatic urethane (meth)acrylate which has two ethylenically unsaturated double bonds per molecule and contains at least one polytetrahydrofurandiol having a number average molecular weight Mₙ of at least 500 g/mol in built-in form and
b) at least one monoethylenically unsaturated reactive diluent containing at least one aliphatic heterocycle as structural element.

According to the present invention, the aliphatic urethane (meth)acrylate is free of aromatic structural elements such as phenylene or naphthylene or substituted derivatives thereof. Component b) does not contain any aliphatic carbocycles.

In a preferred embodiment, the radiation-curable coating compositions of the present invention further comprise, as component c), a bifunctional or polyfunctional ester of an α,β-ethylenically unsaturated carboxylic acid with an aliphatic diol or polyol.

In general, the compositions of the present invention comprise from 20 to 90% by weight, preferably from 30 to 80% by weight and in particular from 40 to 70% by weight, of the component a), from 10 to 80% by weight, preferably from 20 to 60% by weight and in particular from 30 to 50% by weight, of the component b), from 0 to 50% by weight, preferably from 0 to 40% by weight, of the component c) and up to 50% by weight, based on the total weight of the components a), b) and c), of customary auxiliaries, with the proviso that the percentages by weight of the components a), b) and c) add up to 100% by weight. In general, the weight of the components b) and c) is in the range from 10 to 80% by weight, preferably from 20 to 70% by weight and in particular from 30 to 60% by weight, in each case based on the total weight of a)+b)+c).

Depending on the desired property profile, the compositions of the present invention comprise component b) and component c) or only component b). If a high hardness of the coating is desired, the preparation of the present invention preferably comprises component b) and component c). On the other hand, if greater importance is placed on a high flexibility, component c) can be omitted. In addition, the viscosity of the preparations of the present invention is improved as the content of component c) increases. In the first case, the ratio of component b) to component c) is preferably in the range from 20:1 to 1:1, in particular in the range from 10:1 to 1.5:1.

The component a) is generally built up essentially of one or more aliphatic structural elements, urethane groups and two ethylenically unsaturated structural units. Aliphatic structural elements include both alkylene groups, preferably those having from 4 to 10 carbon atoms, and cycloalkylene groups, preferably those having from 6 to 20 carbon atoms. Both the alkylene and cycloalkylene groups may be monosubstituted or poly-substituted by C₁-C₄-alkyl, in particular methyl, and contain one or more nonadjacent oxygen atoms. The aliphatic structural elements may be joined to one another via quaternary or tertiary carbon atoms, via urea groups, biuret, uretdione allophanate, cyanurate, urethane, ester or amide groups or via ether oxygen or amine nitrogen. Furthermore, according to the present invention, the component a) contains two ethylenically unsaturated structural elements. These are preferably vinyl or allyl groups which may also be substituted by C₁-C₄-alkyl, in particular methyl, and are derived, in particular, from α,β-ethylenically unsaturated carboxylic acids or their amides. Particularly preferred ethylenically unsaturated structural units are acryloyl and methacryloyl groups such as acrylamido and methacrylamido and in particular acryloxy and methacryloxy.

Particular preference is given to components a) in which the aliphatic structural elements are joined to one another via cyanurate, biuret and/or urethane groups and which have acryloxy groups as ethylenically unsaturated structural elements.

The number average molecular weight Mₙ of the urethane (meth)acrylates a) is preferably in the range from 750 to 10000, particularly preferably from 1000 to 5000.

Such ethylenically unsaturated prepolymers containing urethane groups are known in principle to those skilled in the art. Preferred aliphatic urethanes which are free of urea groups can be obtained, for example, by reacting
i) at least one aliphatic compound or an aliphatic prepolymer having at least two isocyanate groups (component a1) with
ii) at least one compound having at least one reactive OH group and at least one ethylenically unsaturated double bond (component a2),
iii) at least one polytetrahydrofurandiol (polytetramethylene glycol, polytetramethylene oxide) having a number average molecular weight Mₙ of at least 500 g/mol and optionally
iv) one or more aliphatic compounds having at least one reactive OH group (component a4).

The ratio of the sum of the OH groups from the components a2, a3 and a4 to the NCO groups from the component a1 is preferably ≧1, so that the urethane (meth)acrylate obtained generally contains no NCO groups.

As component a1, it is possible to use aliphatic diisocyanates, oligomeric adducts of aliphatic diisocyanates with polyfunctional alcohols having preferably from 2 to 20 carbon atoms and also uretdiones, isocyanurates, biurets and allophanates of aliphatic diisocyanates. Examples of suitable aliphatic diisocyanates are tetramethylene diisocyanate, hexamethylene diisocyanate, octamethylene diisocyanate, decamethylene diisocyanate, dodecamethylene diisocyanate, tetradecamethylene diisocyanate, 1,6-diisocyanato-2,2,4-trimethylhexane, 1,6-diisocyanato-2,2,4,4-tetramethylhexane, 1,2-, 1,3- or 1,4-diisocyanatocyclohexane, 4,4′-di(isocyanatocyclohexyl)methane, 1-isocyanato-3,3,5-trimethyl-5-(isocyanatomethyl)cyclohexane (=isophorone diisocyanate) and 2,4- or 2,6-diisocyanato-1-methylcyclohexane. Suitable polyfunctional alcohols include aliphatic diols or polyols, preferably those having from 2 to 20 carbon atoms, e.g. ethylene glycol, diethylene glycol, triethylene glycol, 1,2-propylene glycol, 1,3-propylene glycol, dipropylene glycol, tripropylene glycol, 1,4-butanediol, 1,5-pentanediol, neopentyl glycol, 1,6-hexanediol, 2-methyl-1,5-pentanediol, 2-ethyl-1,4-butanediol, dimethylolcyclohexane, glycerol, trimethylolethane, trimethylolpropane, trimethylolbutane, pentaerythritol, ditrimethylolpropane, erythritol and sorbitol. The component a1 can also be selected from among the trimerization products of the abovementioned aliphatic diisocyanates, i.e. the biurets and the isocyanurates, and the adducts of the abovementioned aliphatic diisocyanates with one of the abovementioned polyfunctional aliphatic alcohols having at least three reactive OH groups. Such compounds include, for example, the isocyanurate and/or the biuret of hexamethylene diisocyanate. Particularly preferred components a1 are isophorone diisocyanates and mixtures containing isophorone diisocyanate.

As component a2, it is possible to use, for example, the esters of ethylenically unsaturated carboxylic acids with one of the abovementioned aliphatic polyols and also the vinyl, allyl and methallyl ethers of the abovementioned polyols, as long as they still contain an OH group which is reacted toward isocyanate. Furthermore, the amides of ethylenically unsaturated carboxylic acids with amino alcohols can also be used. The esters of acrylic acid and of methacrylic acid, e.g. hydroxyethyl(meth)acrylate, hydroxypropyl(meth)acrylate, 1,4-butanediol mono(meth)acrylate, neopentyl glycol mono(meth)acrylate, trimethylolpropane di(meth)acrylate, pentaerythritol di(meth)acrylate and tri(meth)acrylate are preferred as component a2. The component a2 is particularly preferably selected from among hydroxypropyl acrylate and butanediol monoacrylate and is in particular hydroxyethyl acrylate.

The component a3) is preferably a polymer having a number average molecular weight in the range from about 500 to 4000, preferably from 600 to 3000, in particular from 750 to 2000. Suitable polytetrahydrofurans can be prepared by cationic polymerization of tetrahydrofuran in the presence of acid catalysts, e.g. sulfuric acid or fluorosulfuric acid. Such preparative methods are known to those skilled in the art. Preference is given to strictly linear polytetrahydrofurans.

Examples of aliphatic compounds having at least one reactive OH group which can additionally be used (component a4) are alkanols having preferably from 1 to 10 carbon atoms, cycloalkanols having preferably from 5 to 10 carbon atoms and monoalkyl ethers of polyalkylene glycols. Suitable alkanols include, for example, methanol, ethanol, n-propanol and isopropanol, n-butanol, 2-butanol, isobutanol and tert-butanol, amyl alcohol, isoamyl alcohol, n-hexanol, n-octanol, 2-ethylhexanol and decanol. Suitable cycloalkanols include, for example, cyclopentanol and cyclohexanol, which may each be monosubstituted or polysubstituted by C₁-C₄-alkyl, e.g. methyl, ethyl, n-propyl, isopropyl, n-butyl, 2-butyl, isobutyl or tert-butyl, in particular by methyl. Examples of monoalkyl ethers of polyalkylene glycols are the mono-C₁-C₄-alkyl ethers and in particular the methyl ethers of ethylene glycol, of diethylene glycol or of triethylene glycol.

The component a) is prepared in a known manner by reacting the component a1 with the components a2 and a3 and, if desired, a4, preferably at from 0 to 120° C. and in particular at from 20 to 100° C.

To accelerate the reaction, catalysts as described, for example, in Houben-Weyl, Methoden der Organischen Chemie, Vol. XIV/2, Thieme-Verlag, Stuttgart 1963, p. 60f., and Ullmanns Enzyklopädie der Technischen Chemie, 4th Edition, Vol. 19 (1981), p. 306, can be used. Preference is given to tin-containing catalysts such as dibutyltin dilaurate, tin(II) octoate or dibutyltin dimethoxide. In general, such catalysts are used in an amount of from 0.001 to 2.5% by weight, preferably from 0.005 to 1.5% by weight, based on the total amount of reactants.

To stabilize the free-radically polymerizable compounds (component a2), polymerization inhibitors are added to the reaction in amounts of preferably from 0.001 to 2% by weight, in particular from 0.005 to 1.0% by weight. These inhibitors are the customary compounds suitable for suppressing free-radical polymerization, e.g. hydroquinones or hydroquinone monoalkyl ethers, 2,6-di-tert-butylphenols such as 2,6-di-tert-butylcresol, nitrosamines, phenothiazines or phosphorous esters. The reaction can be carried out either in the absence of solvents or with addition of solvents. Possible solvents are inert solvents, e.g. acetone, methyl ethyl ketone, tetrahydrofuran, dichloromethane, toluene, C₁-C₄-alkyl esters of acetic acid, e.g. ethyl acetate or butyl acetate. The reaction is preferably carried out in the absence of solvents or in at least part of the component b) as solvent.

As component b), it is in principle possible to use all monofunctional esters of α,β-ethylenically unsaturated carboxylic acids with a monofunctional alkanol containing at least one saturated 5- or 6-membered heterocycle having one or two oxygen atoms in the ring as structural element. The component b) is preferably derived from acrylic acid or methacrylic acid. Examples of suitable compounds of the component b) include compounds of the formula I 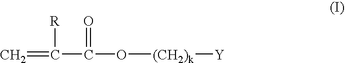
where
R is selected from among H and CH₃ and is in particular H,
k is from 0 to 4, in particular 0 or 1, and
Y is a 5- or 6-membered, saturated heterocycle containing one or two oxygen atoms, with the heterocycle being able to be unsubstituted or substituted by C₁-C₄-alkyl, e.g. methyl, ethyl, n-propyl, isopropyl, n-butyl, 2-butyl, isobutyl or tertbutyl.

The 5- or 6-membered, saturated heterocycle is preferably derived from tetrahydrofuran, tetrahydropyran, 1,3-dioxolane, 1,3- or 1,4-dioxane.

The component b) is particularly preferably selected from among trimethylolpropane monoformal acrylate, glycerol monoformal acrylate, 4-tetrahydropyranyl acrylate, 2-tetrahydropyranyl methylacrylate, tetrahydrofurfuryl acrylate and mixtures thereof. Very particular preference is given to using trimethylolpropane monoformal acrylate as component b).

In addition, the radiation-curable coating compositions can contain the abovementioned amounts of a bifunctional or polyfunctional ester of an α,β-ethylenically unsaturated carboxylic acid with an aliphatic diol or polyol (component c). Examples of suitable compounds of this type are the esterification products of the diols or polyols mentioned above in connection with component a1. Preference is given to the esters of acrylic acid and of methacrylic acid, in particular the diesters of diols. The diols or polyols preferably contain no further heteroatoms apart from the OH functions. Examples of suitable components c) include ethylene glycol di(meth)acrylate, propylene glycol di(meth)acrylate, butylene glycol di(meth)acrylate, 1,6-hexanediol di(meth)acrylate, diethylene glycol di(meth)acrylate, triethylene glycol di(meth)acrylate, dipropylene glycol di(meth)acrylate, tripropylene glycol di(meth)acrylate, 1,4-cyclohexanediol di(meth)acrylate and 1,4-bis(hydroxymethyl)cyclohexane di(meth)acrylate, also trimethylolethane tri(meth)acrylate, trimethylolpropane tri(meth)acrylate and pentaerythritol tetra(meth)acrylate. Particularly preferred components c) are butanediol diacrylate, hexanediol diacrylate, 1,4-cyclohexanediol diacrylate and 1,4-bis(hydroxymethyl)cyclohexane diacrylate.

Furthermore, the radiation-curable coating compositions of the present invention can, depending on the intended use, contain up to 50% by weight (without pigments and fillers) of customary auxiliaries such as photoinitiators, free-radical scavengers, thickeners, leveling agents, antifoams, UV stabilizers, slip additives, etc.

The coating compositions of the present invention preferably further comprise, based on the total weight of the components a), b) and c):

d) from 0 to 10% by weight of at least one photoinitiator,

e) from 0 to 5% by weight of at least one UV absorber,

f) from 0 to 5% by weight of at least one free-radical scavenger and

g) from 0 to 10% by weight of additives customary for coating compositions.

In addition, the coating compositions of the present invention can further comprise, based on the total weight of the components a), b) and c), from 0 to 200% by weight, preferably from 0 to 100% by weight, of at least one particulate additive selected from among pigments and fillers. The amount of pigments customarily used is, for example, in the range from 2 to 40% by weight. The amount of fillers customarily used is, for example, in the range from 1 to 30% by weight.

Suitable stabilizers include typical UV absorbers such as oxanilides, triazines and benzotriazole (the latter obtainable as Tinuvin® grades from Ciba-Spezialitätenchemie) and benzophenones. These can be used either alone or together with suitable free-radical scavengers, for example sterically hindered amines such as 2,2,6,6-tetra-methylpiperidine, 2,6-di-tert-butylpiperidine or derivatives thereof, e.g. bis(2,2,6,6-tetramethyl-4-piperidyl)sebacate. Stabilizers are usually used in amounts of from 0.1 to 5.0% by weight, preferably from 0.5 to 3.5% by weight, based on the components a) to c) present in the preparation.

If curing is carried out by means of UV radiation, the preparations of the present invention contain at least one photoinitiator which can initiate the polymerization of ethylenically unsaturated double bonds. Such initiators include benzophenone and benzophenone derivatives such as 4-phenylbenzophenone and 4-chlorobenzophenone, Michler's ketone, anthrone, acetophenone derivatives such as 1-benzoylcyclohexan-1-ol, 2-hydroxy-2,2-dimethylacetophenone and 2,2-dimethoxy-2-phenylacetophenone, benzoin and benzoin ethers such as benzoin methyl, ethyl and butyl ethers, benzil ketals such as benzil dimethyl ketal, 2-methyl-1-[4-(methylthio)phenyl]-2-morpholinopropan-1-one, anthraquinone and its derivatives such as b-methylanthraquinone and tert-butylanthraquinone, acyl phosphine oxides such as 2,4,6-trimethylbenzoyldiphenylphosphine oxide, ethyl 2,4,6-trimethylbenzoyl-phenylphosphinate and bisacylphosphine oxides. The abovementioned photoinitiators are, if required, used in amounts of from 0.05 to 20% by weight, preferably from 0.1 to 10% by weight and in particular from 0.1 to 5% by weight, based on the polymerizable components a), b) and c) of the preparations of the present invention. If the preparation of the present invention is cured by means of an electron beam, photoinitiators can be omitted. When electron beam curing is employed, the preparations of the present invention can also contain colored pigments.

The preparations of the present invention preferably contain no pigments or fillers. Furthermore, the preparations of the present invention are preferably free of nonpolymerizable inert solvents.

The compositions of the present invention are prepared by mixing the components in a customary fashion. Mixing can be carried out at room temperature or at elevated temperature up to 100° C., for example by means of customary mixing apparatuses such as stirred vessels or static mixers.

The preparations of the present invention have been found to be particularly useful for coating substrates such as wood, paper, plastic surfaces, leather and, in particular, metals or coated metals.

Accordingly, the present invention also provides a process for coating substrates, in particular metals or coated metals, and also the coated substrates obtainable by means of this process. The coating of the substrates is generally carried out by applying at least one radiation-curable preparation according to the present invention in the desired thickness to the substrate to be coated, if appropriate removing solvent present and subsequently curing the composition by action of high-energy radiation such as UV radiation or electron beam. This procedure can, if desired, be repeated one or more times. The radiation-curable preparations are applied to the substrate in a known manner, e.g. by spraying, knife coating, doctor blade coating, brushing, rolling or casting. The amount of coating is generally in the range from 3 to 500 g/m², preferably from 10 to 200 g/m², corresponding to wet film thicknesses of from about 3 to 500 mm and preferably from 10 to 200 mm. Application can be carried out either at room temperature or at elevated temperature, but preferably not above 100° C. The coatings are subsequently cured by action of high-energy radiation, preferably UV radiation having a wavelength of from 250 to 400 nm or by irradiation with high-energy electrons (electron beam; 150 to 300 keV). UV sources which can be used are, for example, high-pressure mercury vapor lamps, e.g. CK or CK1 lamps from IST. The radiation dose sufficient for crosslinking is usually in the range from 80 to 3000 mJ/cm².

In a preferred process, curing is carried out continuously by moving the substrate which has been treated with the preparation according to the present invention at a constant speed past a radiation source. In this case, it is necessary for the curing rate of the preparation of the present invention to be sufficiently high.

The preparations of the present invention have a high reactivity of >10 m/min (the reactivity in m/min corresponds to the speed at which a substrate treated with a radiation-curable preparation in a wet film thickness of 100 mm can be moved past a UV source having a power of 120 W/cm at a distance of 10 cm with complete curing taking place). At the same time, high hardnesses characterized by pendulum damping (method based on DIN 53157, see below) of >8 sec. and high flexibilities characterized by Erichsen indentations of >5 mm (see below) can be achieved without deteriorations in the viscosity and the reactivity being observed. Furthermore, the coatings obtainable from the preparations of the present invention display an increased scratch resistance, as can be determined, for example, by means of scouring tests.

The examples below illustrate the present invention without restricting it.

### EXAMPLES

A) Production of Polyurethanes, Surface Coating Compositions and Coatings

### Example 1

Preparation of a Polyurethane Resin Based on a Polytetrahydrofurandiol (Mₙ=1000 g/mol)

450 parts of polytetrahydrofurandiol (Mₙ=1000 g/mol), 105 parts of hydroxyethyl acrylate, 250 parts of trimethylolpropane formal monoacrylate, 0.4 part of hydroquinone monomethyl ether and 0.1 part of dibutyltin dilaurate are placed in a round-bottom flask and heated to 80° C. 200 parts of isophorone diisocyanate were then added dropwise over a period of half an hour. The mixture is allowed to react for a further 5 hours until the isocyanate group content of the mixture (NCO value) has dropped to 0. The resin obtained is filtered through a 50 μm filter and packaged.

### Example 2

Preparation of a Polyurethane Resin Based on a Polytetrahydrofurandiol (Mₙ=2000 g/mol)

The procedure of Example 1 is repeated using a polytetrahydrofurandiol having a molecular weight of 2000 g/mol.

### Example 3

Preparation of a Polyurethane Resin Based on a Polytetrahydrofurandiol (Mₙ=650 g/mol)

The procedure of Example 1 is repeated using a polytetrahydrofurandiol having a molecular weight of 650 g/mol.

### Comparative Examples 1 and 2

Preparation of Polyurethane Resins as Described in U.S. Pat. No. 4,135,007

The general procedure of Example 1 is repeated using ethylhexyl acrylate (C1) or cyclohexyl methacrylate (C2) in place of the reactive diluent trimethylolpropane formal monoacrylate.

### Comparative Example 3

Preparation of a Polyurethane Resin Based on a Polyester Diol

The procedure of Example 1 is repeated using a polyester diol derived from adipic acid and 1,4-butanediol and having a molecular weight (Mₙ) of 1000 g/mol in place of the polytetrahydrofurandiol.

Production of Surface Coating Compositions:

96 parts of the resins from Examples 1-3 and Comparative Examples 1-3 are in each case admixed with 4 parts of the photoinitiator Darocure 1173 (from Ciba). The viscosities of the surface coating compositions obtained are reported in Table 1 below.

| | Viscosity [Pas] |
|---|---|
| Example 1 | 11 |
| Example 2 | 50 |
| Example 3 | 12 |
| C1 | — |
| C2 | — |
| C3 | 40 |

Production of Coatings:

The above-described surface coating compositions are applied to a black glass plate and to a bonderized steel sheet using a 100 μm box center and illuminated at 1320 mJ/cm².

B) Use Properties

The surface coating compositions from the examples and the comparative examples were then applied in the layer thicknesses described for the respective test method and cured.

Measurement Conditions:

Pendulum Damping: (Based on DIN 53157)

100 μm wet film thickness, illuminated by means of a high pressure Hg vapor lamp, 120 W/cm; distance to object: 10 cm; belt speed 2×10 m/min; pendulum apparatus in accordance with DIN 53157 (König); reported in sec.).

Erichsen Indentation: (Based on DIN 53156)

50 μm wet film thickness with spiral coater; illuminated by means of a high-pressure Hg vapor lamp, 120 W/cm; distance to object 10 cm; belt speed: 2×10 m/min; Erichsen indentation in accordance with DIN 53156; reported in mm).

The scratch resistance was assessed in a scouring test in which 10 double strokes were performed with a piece of Scotchbrite under a weight of 750 g. The degree of scratching was determined by determining the decrease in gloss (before and after the scouring treatment). The smaller the decreasing gloss, the better the scratch resistance.

The coatings produced according to the examples corresponding to the present invention and the comparative examples display the following properties:

All coatings are transparent and colorless.

| | Pendulum damping | Erichsen indentation | Decrease in gloss |
|---|---|---|---|
| Example 1 | 9 s | >9.5 mm | 15% |
| Example 2 | 22 s | >9.5 mm | 33% |
| Example 3 | 9 s | >9.5 mm | 25% |
| C1 | 28 s | 8.9 mm | 54% |
| C2 | 4 s | >9.5 mm | 62% |
| C3 | 4 s | >9.5 mm | 70% |

The comparison shows that flexible surface coatings having a significantly improved scratch resistance are obtained.

1: A radiation-curable coating composition comprising
a) at least one aliphatic urethane (meth)acrylate which has two ethylenically unsaturated double bonds per molecule and comprises at least one polytetrahydrofurandiol having a number average molecular weight Mₙ of at least 500 g/mol, and
b) at least one monoethylenically unsaturated reactive diluent comprising at least one aliphatic heterocycle,
wherein the component b) is a compound of the formula I 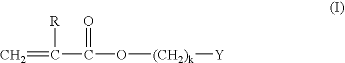
wherein
R is selected from the group consisting of H and CH₃,
k is from 0 to 4, and
Y is a 5- or 6-membered, saturated heterocycle comprising one or two oxygen atoms, with the heterocycle being able to be unsubstituted or substituted by C₁-C₄-alkyl.

2: The coating composition as claimed in claim 1 which further comprises as component c) a bifunctional or polyfunctional ester of an α,β-ethylenically unsaturated carboxylic acid with a diol or polyol.

3: The coating composition as claimed in claim 2 comprising from 20 to 90% by weight of the component a), from 10 to 80% by weight of the component b), from 0 to 50% by weight of the component c) and up to 50% by weight, based on the total weight of the components a), b) and c), of at least one auxiliary, with the proviso that the percentages by weight of the components a), b) and c) add up to 100% by weight.

4: The coating composition as claimed in claim 2 which, based on the total weight of the components a), b) and c), further comprises:
d) from 0 to 10% by weight of at least one photoinitiator,
e) from 0 to 5% by weight of at least one UV absorber,
f) from 0 to 5% by weight of at least one free-radical scavenger, and
g) from 0 to 10% by weight of at least one additive.

5: The coating composition as claimed in claim 1, wherein the component b) is selected from the group consisting of trimethylolpropane monoformal acrylate, glycerol monoformal acrylate, 4-tetrahydropyranyl acrylate, 2-tetrahydropyranyl methylacrylate and tetrahydrofurfuryl acrylate.

6: The coating composition as claimed in claim 2, wherein the component c) is selected from the group consisting of diacrylates and dimethacrylates of aliphatic diols.

7-8. (canceled)

9: A process for producing a coated substrate, which comprises
applying the coated composition as claimed in claim 1 to the surface of a substrate,
optionally, drying the applied coating composition at elevated temperatures, and
curing the coating composition, by irradiation with UV radiation or an electron beam, to form the coated substrate.

10: A coated substrate obtained by the process of claim 9.

11: The process of claim 10, wherein the substrate surface comprises wood, plastic, paper, leather, metal, or combinations thereof.

12: The process of claim 10, comprising drying the applied coating composition at elevated temperatures.

13: A process for producing a coated substrate, which comprises
applying the coated composition as claimed in claim 2 to the surface of a substrate,
optionally, drying the applied coating composition at elevated temperatures, and curing the coating composition by irradiation with UV radiation or an electron beam, to form the coated substrate.

14: A coated substrate obtained by the process of claim 13.

15: The process of claim 13, wherein the substrate surface comprises wood, plastic, paper, leather, metal, or combinations thereof.

16: The process of claim 13, comprising drying the applied coating composition at elevated temperatures claim 17: A process for producing a coated substrate, which comprises
applying the coated composition as claimed in claim 3 to the surface of a substrate,
optionally, drying the applied coating composition at elevated temperatures, and
curing the coating composition by irradiation with UV radiation or an electron beam, to form the coated substrate.

18: A coated substrate obtained by the process of claim 17.

19: The process of claim 17, wherein the substrate surface comprises wood, plastic, paper, leather, metal, or combinations thereof.

20: The process of claim 17, comprising drying the applied coating composition at elevated temperatures.

21: A process for producing a coated substrate, which comprises
applying the coated composition as claimed in claim 4 to the surface of a substrate,
optionally, drying the applied coating composition at elevated temperatures, and
curing the coating composition by irradiation with UV radiation or an electron beam, to form the coated substrate.

22: A coated obtained by the process of claim 21.
